(19) United States
(12) Patent Application Publication
(10) Pub. No.: US 2025/0099880 A1
(43) Pub. Date: Mar. 27, 2025

(54) Hydraulic sludge recovery system

(71) Applicant: The Board of Trustees of the Leland Stanford Junior University, Stanford, CA (US)

(72) Inventors: Sebastien Tilmans, San Francisco, CA (US); Himanshu K. Khuntia, Palo Alto, CA (US); Ken M. Stedman, San Clemente, CA (US)

(21) Appl. No.: 18/889,686

(22) Filed: Sep. 19, 2024

Related U.S. Application Data
(60) Provisional application No. 63/539,896, filed on Sep. 22, 2023.

(51) Int. Cl. B01D 24/44; B01D 24/24; B01D 24/46

(52) U.S. Cl. CPC B01D 24/44; B01D 24/24; B01D 24/4668; B01D 2101/04

(57) ABSTRACT

A continuous backwash upflow media filter comprises a container having a conical bottom; a wastewater influent tube having an opening within the container; an effluent weir within the container and an effluent tube with an opening in the effluent weir; a reject weir within the container below the effluent weir and a reject tube with an opening in the reject weir; an inverted deflection cone within the container positioned below the opening of the wastewater influent tube forming an annular space between the inverted deflection cone and the conical bottom of the container; an airlift pipe having a lower opening below the inverted deflection cone and below the annular space; and a sludge lift tube having a lower opening inside the media-free cavity formed by the inverted deflection cone above the annular space and an upper opening adapted to discharge sludge out of the container.

### CROSS-REFERENCE TO RELATED APPLICATIONS

This application claims priority from U.S. Provisional Patent Application 63/539,896 filed Sep. 22, 2023, which is incorporated herein by reference.

### STATEMENT OF FEDERALLY SPONSORED RESEARCH

None.

### FIELD OF THE INVENTION

The present invention relates generally to wastewater treatment devices. More specifically, it relates to continuous backwash upflow media filters.

### BACKGROUND OF THE INVENTION

About 50-88% of influent organic material in municipal wastewater treatment plants is in a particulate form that is not rapidly biodegradable. Much of the chemical oxygen demand (COD) organic matter in raw wastewater (50-60%) passes through typical primary clarifiers into a conventional activated sludge (CAS) system. Particulate matter requires a long residence time in a CAS system to complete the rate-limiting hydrolysis step, requiring large reactor and clarifier footprints. Wastewater must be continuously aerated during hydrolysis, requiring substantial energy. About half or more of the chemical energy (as COD organic matter) entering a CAS system is lost as CO2, and only one third is transferred to biomass (biosolids) with a potential energy value. This biomass has a high initial moisture content (97-99.9%) and poor dewaterability, hampering resource recovery strategies for direct energy recovery via combustion or gasification. It is also only 30-50% digestible, limiting the efficiency of resource recovery efforts via anaerobic digestion. The end result of these limitations is that at best 20-50% of the chemical energy in wastewater COD organic matter can be recovered using a CAS system.

An alternative to biological treatment of these solids is to filter them out of the wastewater early in the treatment process and concentrate them so their energy value can be harnessed. However, traditional filtration approaches are inadequate for this task because the particulates rapidly clog traditional media. Primary filtration techniques, such as cloth media filtration, require specialized filter media whose supply chains reduce their applicability in many parts of the world where wastewater treatment is required.

A type of filter called a continuous backwash upflow media filter (CBUMF) has been employed at length in water filtration and in tertiary filtration of wastewater, where solids loads are much lower than they are upstream in primary treatment.

The operation of a conventional CBUMF exhibits stable performance under low solids loading rates. However, even at the optimum hydraulic and solids loads, an influx of high particulates disrupts the filter operation. Higher influx of particulates in the influent result in a higher amount of particulate separation and its subsequent accumulation at the bottom of the cone. The build-up of the sludge creates a higher head pressure by plugging the filter and overwhelming it, yielding process failure. In such scenarios, the CBUMF operation must be halted for a period of up to 30 min to 3 hours and restarted after normalization in head pressure. Because conventional CBUMFs are designed to operate only under low solid loads, they are vulnerable to particulate influx and are not suitable for use in primary treatment of wastewater, where there is a large influx of solids and the loads are high.

### SUMMARY OF THE INVENTION

Herein is disclosed improvements to the conventional CBUMF that achieves simultaneous removal of sludge, fats, oils and grease (FOG), and airlocks from the inner deflection cone resulting in reduced head pressures. The improved design enables the operation of a CBUMF at higher solids loads and the capability to withstand spikes in influent solids loading without interrupting steady state operations.

The inventors discovered, surprisingly, that sludge accumulates in the inverted cone of the filter, where it remains trapped. This observation is counterintuitive, as sludge in primary treatment systems typically accumulates at the low point of treatment vessels. In an improved CBUMF according to embodiments of the present invention, a separate hydraulically independent removal of sludge is provided that bypasses the media washer without the need for moving filter media. This sludge removal and recovery is implemented as a hydraulic sludge recovery system (HSRS), which removes sludge that accumulates in the inverted cone. In contrast to the primary airlift, the HSRS sludge is directly ejected from the top of the filter and discarded via the reject channel without passing through the media washer. This distinction allows the removal of sludge from the CBUMF filter without the negative hydraulic effect that would be caused by increased throughput through the primary airlift. The suction end of the HSRS is preferably positioned toward the top of the inverted cone to remove floating sludge and debris without accidental intake of media. At sufficient influent head pressure, the hydraulic head can provoke sludge removal through the HSRS using only the hydraulic head gradient. Air can be injected into the HSRS tube to further increase the sludge removal rate, or to remove sludge under low head pressure or when the filters have no flow. Air injection can also prevent clogging and obstruction of the pipe by sludge/sediment/media debris. The rate of sludge removal can be controlled by the rate of air injection or by a throttling valve at the outlet of the HSRS.

In one aspect, the invention provides a continuous backwash upflow media filter comprising: a container having a conical bottom; a wastewater influent tube having an opening within the container; an effluent weir within the container and an effluent tube with an opening in the effluent weir; a reject weir within the container and a reject tube with an opening in the reject weir, wherein the reject weir is positioned below the effluent weir; an inverted deflection cone within the container positioned below the opening of the wastewater influent tube forming an annular space between the inverted deflection cone and the conical bottom of the container; an airlift pipe having a lower opening below the inverted deflection cone and below the annular space, wherein the airlift pipe has an upper opening positioned below the effluent weir and above the reject weir; and a sludge lift tube having a lower opening inside the inverted deflection cone above the annular space, wherein the sludge lift tube has an upper opening adapted to discharge sludge out of the container.

The lower opening of the sludge lift tube is preferably positioned within a media-free cavity formed by the inverted deflection cone. The continuous backwash upflow media filter may also include an air injection tube connected to the sludge lift tube. The continuous backwash upflow media filter may also include a throttling valve controlling flow through the sludge lift tube. The sludge lift tube is preferably movable so that the lower opening of the sludge lift tube is adjustable vertically within the inverted deflection cone. The length of the sludge lift tube is preferably adjustable so that the lower opening of the sludge lift tube is adjustable vertically within the media-free cavity formed by the inverted deflection cone. The length of the sludge lift tube may be adjustable automatically.

The continuous backwash upflow media filter may also include one or more additional sludge lift tubes having lower openings inside the inverted deflection cone above the opening of the first sludge lift tube. The continuous backwash upflow media filter may also include throttling valves controlling flow through the additional lift tubes. The continuous backwash upflow media filter may also include air injection tubes connected to the additional lift tubes.

This improved CBUMF has applications as a filter for treatment of wastewater with a high quantity of particulate matter, such as municipal wastewater. In addition to use in a primary filtration application, it may also provide benefits in other applications including using a CBUMF as a biological filter in secondary treatment, using a CBUMF as a replacement for conventional secondary clarifiers, and in tertiary filtration applications. More generally, the HSRS can enable the application of the CBUMF for extraction and recovery of fine solids from a fluid mixture with a high solids concentration.

Another benefit is energy capture. Conventional primary treatment allows a large fraction of influent solids to pass through the treatment process, where it proceeds to biological treatment and provokes high energy consumption and losses. The improved CBUMF captures these solids and enables the harnessing of their energy value while reducing the required size and energy of downstream treatment.

### BRIEF DESCRIPTION OF THE DRAWINGS

FIG. 1 is a cross-sectional diagram of a continuous backwash upflow media filter incorporating a sludge removal and recovery system, according to an embodiment of the invention.

FIG. 2 is a cross-sectional diagram of a basic hydraulic sludge recovery system deployment, with the elevation of the HSRS inlet set at 50 cm above the elevation of the primary airlift, according to an embodiment of the invention.

FIG. 3 is a cross-sectional diagram of a hydraulic sludge recovery system deployment with the elevation of the first hydraulic sludge recovery system inlet set at 50 cm above the elevation of the primary airlift and a second hydraulic sludge recovery system with an inlet elevation set higher to capture floatable constituents, according to an embodiment of the invention.

FIG. 4 is a cross-sectional diagram of a hydraulic sludge recovery system deployment with adjustable inlet elevation to capture constituents of different densities in the media-free cavity created by the inverted cone, according to an embodiment of the invention.

FIG. 5 is a graph of head pressure versus time for a continuous backwash upflow media filter fed with high suspended solids with an inactive hydraulic sludge recovery system. Effect on head pressure and system shutdown are shown.

FIG. 6 is a graph of head pressure versus time for a continuous backwash upflow media filter fed with high suspended solids with an active hydraulic sludge recovery system, showing the effect on head pressure and averted system shutdown.

### DETAILED DESCRIPTION OF THE INVENTION

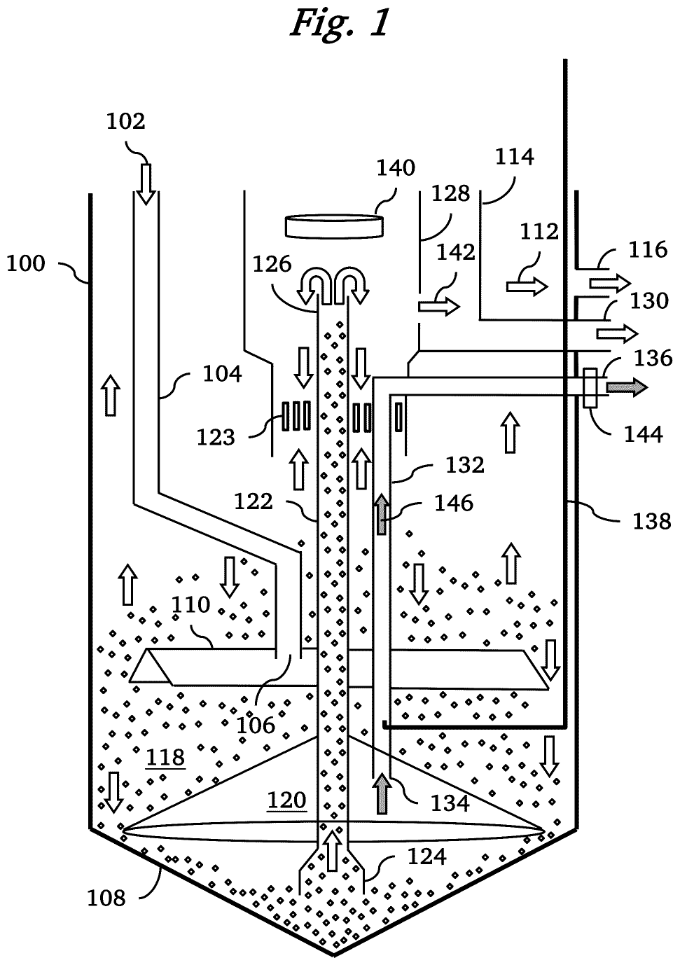

FIG. 1 is a schematic cross-sectional diagram of a CBUMF incorporating a hydraulically independent sludge removal and recovery mechanism, according to an embodiment of the invention.

In operation, wastewater influent 102 is fed into the CBUMF container 100 from the top and flows down through an influent pipe 104 and is injected into the container through a bottom opening 106. The opening is positioned above a conical bottom 108 of the container 100 preferably at an elevation of approximately 1 m from the bottom. An inverted V-shaped channel 110 connected to the opening 106 maintains a space to avoid clogging the influent nozzles with media. After being injected into the container, the influent moves in an upflow direction through a media bed 118 in the container. The media may be, for example, sand. After rising upwards in the container, it flows as filtered effluent 112 over an effluent weir 114 and exits the CBUMF as treated effluent 112 from a top opening 116. Meanwhile, a mixture of fouled media, wastewater, settleable solids, and suspended solids moves down through the media bed and flows through an annular gap between the conical bottom 108 of the container and a deflection cone 120 which prevents the media bed from clogging the conical bottom.

A vertical airlift pipe 122 having a bottom opening 124 near the lowest point of the conical bottom 108 of the container carries slugs of the fouled media mixture upwards and ejects it from a top opening 126 where it hits a deflector 140. Shear during the airlift facilitates media cleaning as it flows upward. The reject 142, which is composed primarily of topical biofilm, wastewater solids, and dirty water flows into a narrow reject weir 128 and then exits the container through an opening 130. The reject weir 128 elevation is preferably a few centimeters below the elevation of the effluent weir 114 to create a head gradient to discharge reject by gravity. The height of the reject weir preferably can be adjusted to control the reject flow rate. Because the fouled media is denser than water, it falls back down through a media washing trough 123 against an upward current of filtered effluent emerging from the media bed 118. The upward flow of filtered water through the media washer 123 prevents filter reject from falling back into the filter. Shear between the media, filter effluent and the uneven media washer surface removes the topical biofilm layer and attached suspended solids from the falling media. The cleaned media falls back to the top of the media bed.

In a conventional CBUMF system, there is a previously unreported tendency for light suspended solids to detach from the media and float upward into the media-free cavity beneath the inverted cone 120. If this sludge accumulates, it eventually escapes from the bottom of the inverted cone and saturates the media bed 118, compromising effluent water quality, elevating filter head pressures, and causing a process shutdown at high solids loading rates.

According to embodiments of the present invention, a sludge removal and recovery component 132, referred to as a hydraulic sludge recovery system (HSRS), removes sludge that accumulates in the inverted cone 120. In contrast to the primary airlift 122 that takes the media mixture from the very bottom of the conical bottom 108 and ejects it within the container, the HSRS 132 has a bottom opening 134 within the inverted cone 120 and it directly conveys the sludge 146 upward and ejects it entirely out of the container through an upper opening 136 to be discarded without passing through the media washer or weirs. This distinction allows the removal of sludge from the CBUMF filter without the negative hydraulic effect that would be caused by increased throughput through the primary airlift. The bottom suction end 134 of the HSRS pipe 132 is positioned toward the top of the inverted cone 120 to remove floating sludge and debris without accidental intake of media. At sufficient influent head pressure, the hydraulic head can provoke sludge removal through the HSRS using only the hydraulic head gradient. In some embodiments, the upper opening 136 of the HSRS can coincide with the opening 130 of the primary airlift reject sludge.

In some embodiments, an air injection tube 138 can be included to inject air into the HSRS tube near its bottom to further increase the sludge removal rate, or to remove sludge under low head pressure or when the filters have no flow. Air injection can also prevent clogging and obstruction of the pipe by sludge/sediment/media debris. The rate of sludge removal can be controlled by the rate of air injection or by a throttling valve 144 near the outlet 136 of the HSRS.

The HSRS can be implemented in various ways. These different HSRS configurations share consistent piping characteristics. Whereas a primary airlift will have a typical pipe diameter of 19-76 mm, the HSRS systems can have a smaller minimum diameter with a typical range of 12-76 mm. Piping materials can be made of metal, for example, stainless steel, or from plastic, including PVC, CPVC, HDPE, PP, or others.

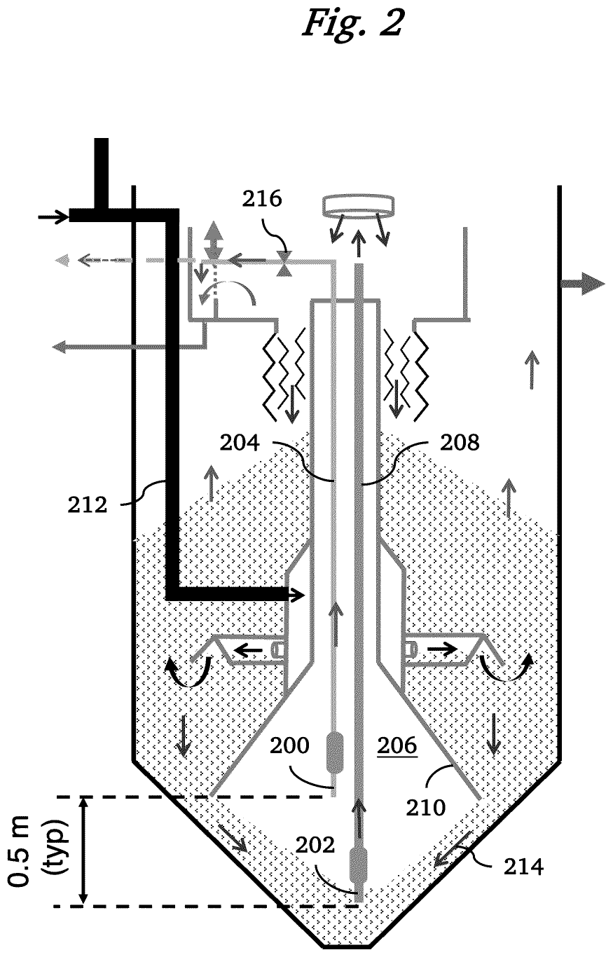

FIG. 2 is a schematic diagram of a basic HSRS deployment, with the elevation of the HSRS inlet 200 set at 50 cm above the elevation of the primary airlift inlet 202. In this implementation, a single HSRS pipe 204 is installed with its inlet 200 positioned within a media-free cavity 206 formed by the inverted deflection cone 210 of the CBUMF filter. The HSRS pipe 204 is sufficiently long such that an operator can manually adjust the elevation of the HSRS inlet 200 by raising or lowering the pipe and anchoring the upper end of the pipe to a fixed support beam. This adjustment allows the operator to identify a single optimal elevation for the HSRS inlet 200 and fix the HSRS at that elevation. The appropriate elevation of the HSRS can depend on the characteristics of the influent wastewater entering through pipe 212. The optimal elevation can be adjusted empirically during system commissioning and may depend somewhat on the dimensions of the system in which it is installed. An elevation of 50 cm above the inlet 202 of the primary airlift 208 is a good initial setpoint, as it is sufficiently far above the media bed 214 to avoid aspirating any filter media, but low enough to remove and draw down a maximum of sludge. The rate of sludge removal can be controlled by a throttling valve 216 near the outlet of the HSRS, by the rate of air injection, or by other mechanisms such as systems that adjust the elevation of the outlet of the HSRS. Air injection can also prevent clogging and obstruction of the pipe by sludge/sediment/media debris.

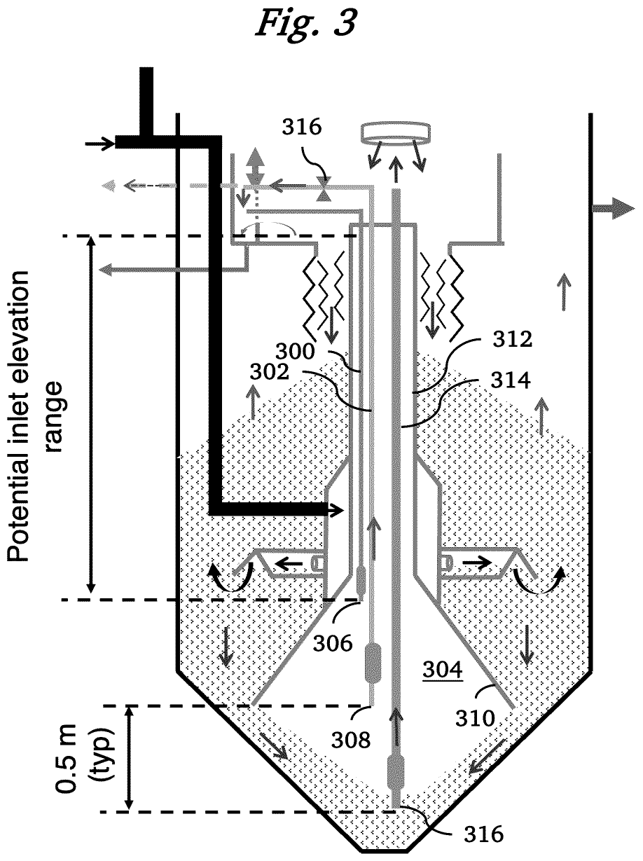

A second embodiment of the HSRS is shown in FIG. 3. This embodiment includes two HSRS pipes 300, 302. Certain undesirable constituents, notably fats, oils, and greases, tend to float in water. These constituents may not be effectively removed by a single HSRS pipe 302 whose inlet 308 is placed in the media-free cavity 304 created by the inverted cone 310. To address this issue, a second HSRS pipe 300 is included, positioned in parallel with the first, with its inlet 306 placed in the media-free cavity 304 at a higher elevation than the inlet 308 of the first. This elevation can coincide with the top of the inverted cone 310 or even be within the sleeve 312 housing the other airlift piping 314. The rate of sludge removal can be controlled by a throttling valve 316 near the outlet of the HSRS, by the rate of air injection, or by other mechanisms such as systems that adjust the elevation of the outlet of the HSRS. Air injection can also prevent clogging and obstruction of the pipe by sludge/sediment/media debris. In this HSRS deployment, the elevation of the first HSRS inlet 308 is preferably set at approximately 50 cm above the elevation of the inlet 316 of the primary airlift 314, and the elevation of the inlet 306 of a second HSRS 300 is set higher than inlet 308 of the first HSRS to capture floatable constituents.

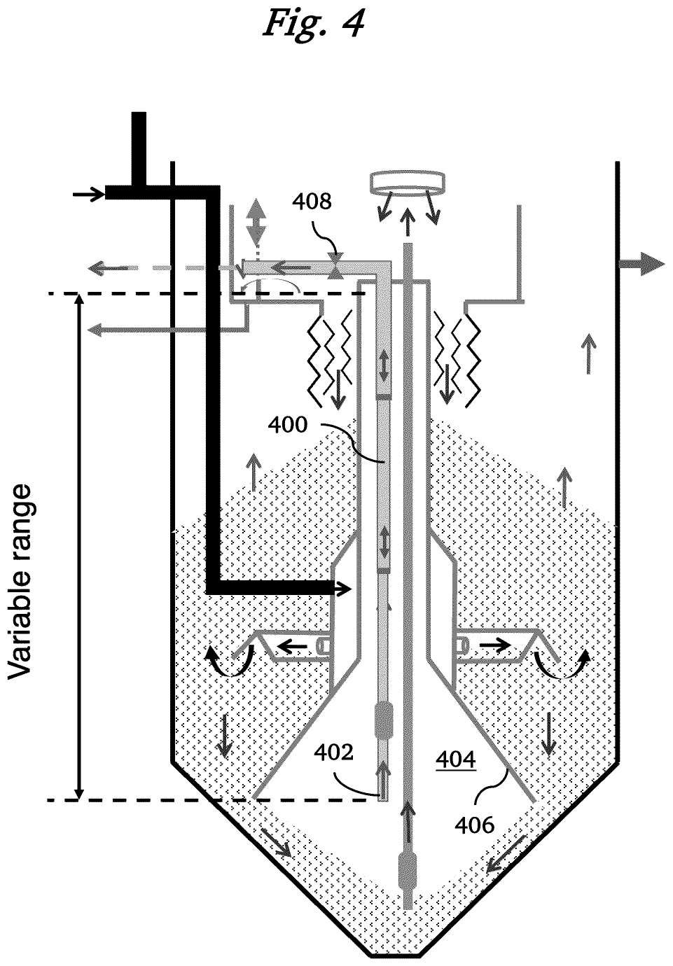

A third configuration of the HSRS is shown in FIG. 4. The embodiment includes only one HSRS pipe 400 having an inlet 402 with an adjustable elevation to capture constituents of different densities in the media-free cavity 404 created by the inverted cone 406. The elevation of the inlet 402 can be adjusted manually or automatically, for example using a telescoping piping system with sleeves, to remove constituents that may have different floatation or settling characteristics. The rate of sludge removal can be controlled by a throttling valve 408 near the outlet of the HSRS, by the rate of air injection, or by other mechanisms such as systems that adjust the elevation of the outlet of the HSRS. Air injection can also prevent clogging and obstruction of the pipe by sludge/sediment/media debris.

The efficacy of the HSRS is clearest when operating a CBUMF under high influent solids loading and/or an influent containing high organics. Two tests were conducted at Stanford's Codiga Resource Recovery Center treating domestic wastewater on a demonstration system processing a flow of about 75 liters/minute (20 gallons/minute) of domestic wastewater that had been subjected to prior microscreening through a 350 μm porosity screen.

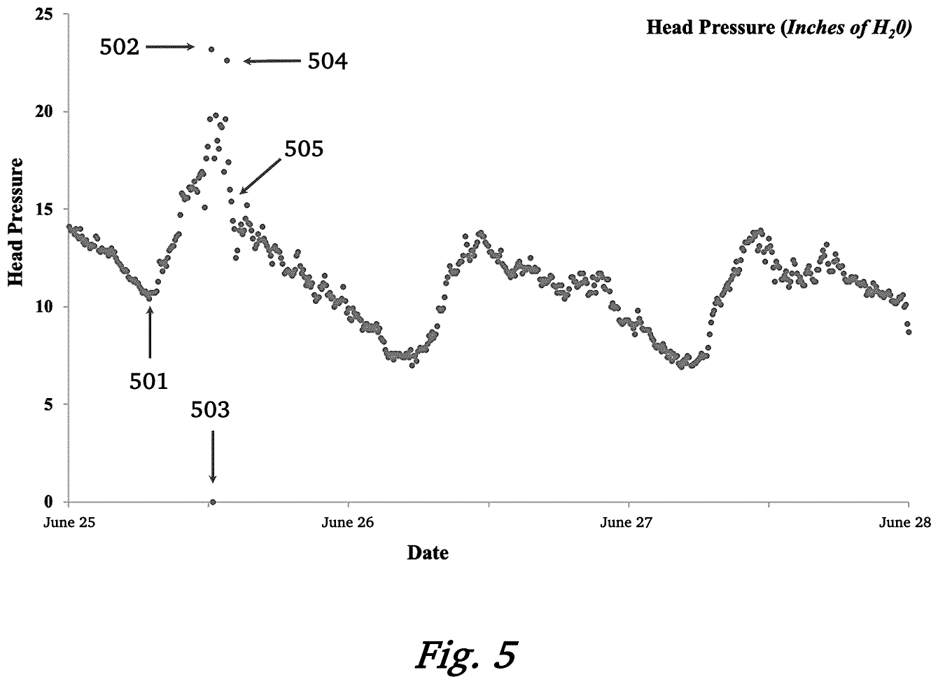

In the first test, the HSRS was shut off to demonstrate the impact of its absence on filter performance and how the HSRS can enable an overloaded CBUMF system to return to regular operations. FIG. 5 is a graph of influent head pressure vs time for a CBUMF fed with high suspended solids with an inactive HSRS. It shows the effect on head pressure and system shutdown. Significant events of the test, indicated in the graph, are as follows:

501: The HSRS was inactivated while feed flow of wastewater continued.

502: A gradual rise in head pressure was observed over the course of 18 hours due to solids accumulation in the media bed and inverted cone.

503: Head pressure rose to a threshold beyond operating limits, triggering a shutdown of the CBUMF system.

504: The CBUMF was restarted with the HSRS operated at a sludge flow of 5-6 LPM without any air injection. The accumulated solids in the inverted cone were ejected by hydraulic pressure and discarded through the reject outlet. A gradual reduction in head pressure was observed.

505: The CBUMF was returned to normal operation with the HSRS operated at a sludge flow of 2-3 LPM.

The suspended solids discarded by the HSRS were subjected to gravimetric analysis. The gravimetric analysis of the rejected solids from the HSRS is as follows: 200 mL settled sludge per Liter. TSS: 1.19 g/L, VSS: 1.16 g/L, SVI: 168 mL/g.

The high solids concentration in the discharge demonstrates the importance of HSRS in selectively and quickly removing the low-density suspended solids from the inverted cone without drawing any media. Moreover, sludge removal via the HSRS can take place independently of the operation of the primary airlift. It also indicates that a certain fraction of the coagulated solids, especially the low-density solids, are less likely to be removed by the primary airlift. They tend to accumulate in the inverted cone and the inner sleeve. In a general day-to-day operation, the low-density solids accumulated in the inverted cone can be continuously removed by the HSRS preventing the issue of sludge build-up and high head pressure.

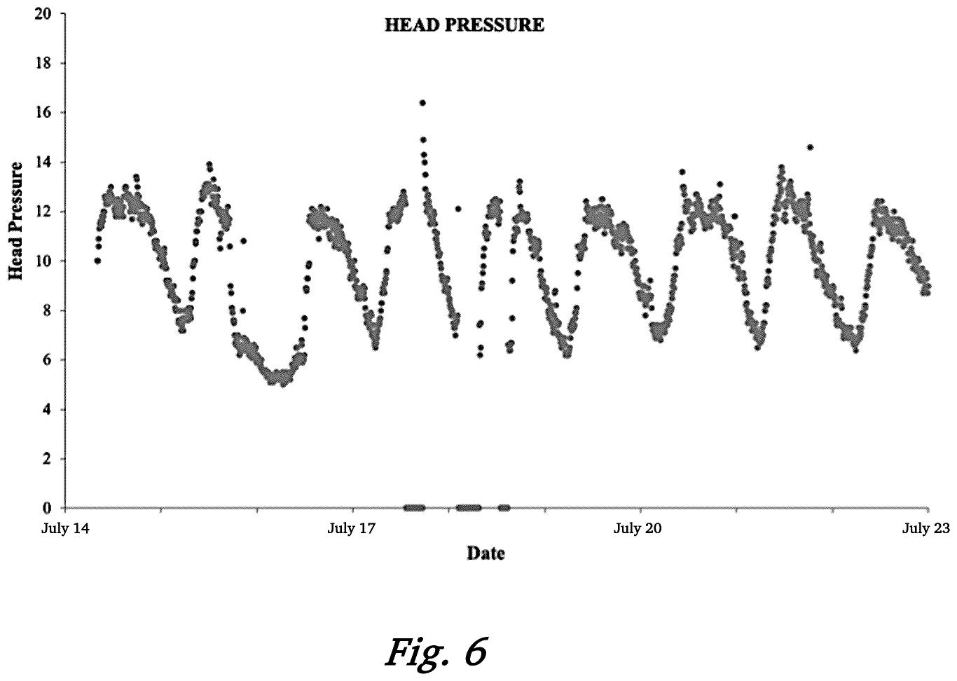

In the second experimental investigation, the CBUMF was operated consistently with the first test while actively engaging/operating the HSRS. FIG. 6 is a graph showing head pressure vs. time for a CBUMF fed with high suspended solids with an active HSRS. The test was conducted for 5 consecutive days with active HSRS. The HSRS was operated without air injection. It used the hydraulic pressures to eject the suspended solids at a discharge rate between 3-5 LPM. Thanks to the HSRS, the CBUMF did not exhibit excessively high head pressure, such that the system could operate continuously without inducing system shutdowns from high influent head.

Operation of the CBUMF to filter microscreened wastewater under high solids loading without use of the HSRS resulted in rapid clogging of the filter over the course of 18 hours, as indicated by high influent head pressure. Operation of the HSRS allowed this clogged filter to return to service. In a subsequent test, operating the CBUMF to filter microscreened solids under comparable loading with the HSRS allowed continuous filtration of the wastewater without clogging incidents over the entire test period of 5 days. The HSRS enables continued operation of the CBUMF filter under high solids loading, whereas the filter will rapidly clog under such conditions without the HSRS.

1. A continuous backwash upflow media filter comprising:
a) a container having a conical bottom;
b) a wastewater influent tube having an opening within the container;
c) an effluent weir within the container and an effluent tube with an opening in the effluent weir;
d) a reject weir within the container and a reject tube with an opening in the reject weir, wherein the reject weir is positioned below the effluent weir;
e) an inverted deflection cone within the container positioned below the opening of the wastewater influent tube forming an annular space between the inverted deflection cone and the conical bottom of the container;
f) an airlift pipe having a lower opening below the inverted deflection cone and below the annular space, wherein the airlift pipe has an upper opening positioned below the effluent weir and above the reject weir;
and
g) a sludge lift tube having a lower opening inside the inverted deflection cone above the annular space, wherein the sludge lift tube has an upper opening adapted to discharge sludge out of the container.

2. The continuous backwash upflow media filter of claim 1
wherein the lower opening of the sludge lift tube is positioned within a media-free cavity formed by the inverted deflection cone.

3. The continuous backwash upflow media filter of claim 1
further comprising an air injection tube connected to the sludge lift tube.

4. The continuous backwash upflow media filter of claim 1
further comprising a throttling valve controlling flow through the sludge lift tube.

5. The continuous backwash upflow media filter of claim 1
wherein the sludge lift tube is movable so that the lower opening of the sludge lift tube is adjustable vertically within the inverted deflection cone.

6. The continuous backwash upflow media filter of claim 1 wherein the length of the sludge lift tube is adjustable so that the lower opening of the sludge lift tube is adjustable vertically within the media-free cavity formed by the inverted deflection cone.

7. The continuous backwash upflow media filter of claim 6 wherein the length of the sludge lift tube is adjustable automatically.

8. The continuous backwash upflow media filter of claim 1
further comprising one or more additional sludge lift tubes having lower openings inside the inverted deflection cone above the opening of the first sludge lift tube.

9. The continuous backwash upflow media filter of claim 8
further comprising throttling valves controlling flow through the additional lift tubes.

10. The continuous backwash upflow media filter of claim 8
further comprising air injection tubes connected to the additional lift tubes.
